(19) United States
(12) Patent Application Publication
(10) Pub. No.: US 2018/0056130 A1
(43) Pub. Date: Mar. 1, 2018

(54) PROVIDING INSIGHTS BASED ON HEALTH-RELATED INFORMATION

(71) Applicant: Microsoft Technology Licensing, LLC, Redmond, WA (US)

(72) Inventors: Hadas Bitran, Ramat Hasharon (IL); Ryen William White, Woodinville, WA (US); Girish Sthanu Nathan, Sammamish, WA (US); Tachen C. Ni, Bellevue, WA (US); Jessica Lundin, Seattle, WA (US); David Earl Heckerman, Santa Monica, CA (US); Gerrit Hendrik Hofmeester, Woodinville, WA (US); Carey Dietz, Lexington, MA (US); Heather Jordan Cartwright, Mercer Island, WA (US); Shahar Yekutiel, Tel Aviv (IL); Arie Schwartzman, Tzur Moshe (IL); Gil Shacham, Ramat Hasharon (IL); Brian Bilodeau, Redmond, WA (US); Todd Holmdahl, Redmond, WA (US); Gabriel A. desGarennes, Issaquah, WA (US)

(73) Assignee: Microsoft Technology Licensing, LLC, Redmond, WA (US)

(21) Appl. No.: 15/428,065

(22) Filed: Feb. 8, 2017

Related U.S. Application Data
(60) Provisional application No. 62/382,195, filed on Aug. 31, 2016.

(51) Int. Cl. A63B 24/00; G06Q 10/10; A63B 71/06; G09B 19/00

(52) U.S. Cl. CPC A63B 24/0075; A63B 2230/65; A63B 71/0622; G09B 19/0092; A63B 2071/0663; A63B 2225/50; A63B 2024/0078; A63B 2230/75; A63B 2220/20; A63B 2220/30; A63B 2220/62; A63B 2230/06; A63B 2230/30; A63B 2230/207; A63B 2230/50; G06Q 10/1097

(57) ABSTRACT

Examples are disclosed herein that relate to integrating health data and calendar data of one or more users and providing insights for a selected user to help the user accomplish an outcome of interest. The insights may be identified based on a group of cohorts determined to be similar to the selected user and/or used to predict a likelihood that the selected user will achieve an outcome of interest. Additional insights may be provided by monitoring an effect that following a recommendation has on the selected user achieving the outcome of interest. Recommendations and/or updates to recommendations may be provided based on the insights.

### CROSS REFERENCE TO RELATED APPLICATIONS

This application claims priority to U.S. Provisional Patent Application No. 62/382,195, filed Aug. 31, 2016, the entirety of which is hereby incorporated herein by reference.

### BACKGROUND

Electronic devices, such as wearables and smart phones, may be configured to track and output information regarding physiological and behavioral characteristics of a person, such as health and fitness data.

### SUMMARY

Examples are disclosed that relate to providing health insights to a user to help the user achieve an outcome of interest. One example provides a computing system configured to receive health information for a user, receive calendar data relating to one or more of a personal schedule and a work schedule of the user, compare the health data and the calendar data to determine a likelihood that the user will meet a health outcome of interest, and, based at least upon determining that the likelihood is below a threshold likelihood, output an alert regarding the health outcome of interest.

Another example provides a computing system configured to receive health information for a plurality of users, the health information regarding one or more of health activities performed by the users and health metrics for the users, and, for a selected user, determine a cohort group comprising other users determined to be similar to the selected user with regard to one or more of location, health condition, user preferences, and user habits. The example computing system is further configured to compare the health information for the selected user with the health information for each user of the cohort group, and output a recommendation for achieving an outcome of interest of the selected user based at least on a result of comparing the health information for the selected user with the health information for each user of the cohort group.

Another example provides a computing system configured to receive health information for a user comprising information regarding health activities performed by the user, receive calendar data for the user relating to one or more of a personal schedule and a work schedule of the user, and output a recommendation for achieving an outcome of interest for the selected user based at least upon the health information for the user and the calendar data for the user. The example computing system is further configured to provide feedback to a user by determining that the user followed the recommendation based at least upon one or more of user input and sensed activity data for the user, and, from sensed health data for the user received after determining that the user followed the recommendation, determine an effect of following the recommendation on progress toward the outcome of interest. The example computing system is further configured to output an alert regarding the effect.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example user interface on a computing device, and illustrates an example health activity alert indicating predictive insights related to an outcome of interest based on calendar data.

FIG. 2 shows an example user interface that illustrates example predictive insights related to an outcome of interest provided based on calendar data and user habits.

FIG. 3A shows an example health activity scheduling alert including a suggestion based on health activities of a cohort group of similar users.

FIG. 3B shows an example health activity scheduling alert based on monitored health information after the user follows the example suggestion illustrated in FIG. 3A.

FIG. 3C shows an example health activity scheduling alert including an alternative suggestion for the user to meet an outcome of interest.

FIGS. 4A and 4B show an example wearable electronic device that may be used in providing health insights.

FIG. 5 shows a block diagram of an example use environment for providing health insights.

FIG. 6 shows an example method of providing a predictive insight related to a health activity.

FIG. 7 shows an example method of determining a cohort group for a selected user.

FIG. 8 shows an example method for providing feedback based upon an effect of having followed a recommendation related to a health activity.

FIG. 9 shows a block diagram of an example computing system.

### DETAILED DESCRIPTION

As mentioned above, various electronic devices, such as wearable or mobile devices, may be configured to track health and fitness-related data for a user, for example, based on sensor data and/or user input information (subjectively tracked data). For example, a mobile device may use location sensors and motion sensors to track movements of the user over time. This data then may be used to determine information such as calories burned, distance traveled, average speed traveled, and inactive time. Wearable devices may comprise additional sensors, such as sensors useable to detect health metrics such as heart rate and heart rate variation, blood pressure (e.g., a blood pressure cuff), blood oxygenation, skin temperature, and galvanic skin response, as non-limiting examples. Subjectively tracked data may be obtained from other devices, such as weight and height scales. Such information may help a user to understand instantaneous health status, as well as to determine trends in the user's health characteristics over time. However, such devices may not provide insight into factors that may influence health characteristics over time, such as times at which exercise is more efficient, and/or times at which exercise may improve sleep quality. Such devices also may not provide insights (whether predictive or retrospective) regarding how to vary such factors to help achieve a health outcome of interest, for example, based on predictive factors, on information collected from similar users (e.g., who are also in a similar location and/or have a similar health status) and/or on observations made after a user follows a recommendation to achieve the health outcome of interest.

Accordingly, examples are disclosed herein that relate to using activity data and work-life data to provide health-related insights via a computing device. Such insights may include predictive insights (e.g. is a user likely to meet a health outcome of interest based upon future work obligations), recommendations based upon cohorts (e.g. similar users based upon location, health factors, and other characteristics such as demographics and health interests), and/or retrospective analysis of an individual's historic data (e.g., personal correlations between sleep and the number of meetings). Such insights also may include user-specific feedback and recommendations to help achieve a health outcome of interest in light of observed effects of following past insights. Further, by considering data from cohorts, the computing system may learn from data regarding other users that are similar to the selected user and provide recommendations to the selected user on how to meet an objective or other outcome of interest based on the learned information.

As described in more detail below, the disclosed examples may consider work-life data and health data for the user and potentially other users to provide recommendations that may help a user to achieve a health-related outcome of interest. The health-related outcome of interest and/or user preferences associated with the recommendations may be selected by the user and/or inferred based on one or more signals, such as search queries, browser behavior, application installation on a user computing device, schedule, employer information, visited venues, workout activities, sleep patterns, and/or any other signal. In some examples, one or more of the signals used to determine or infer the health-related outcome of interest may also be used (e.g., alone or in combination with other signals) to provide the recommendation to help the user achieve the health-related outcome of interest. Example health data may include such information as exercise efficiency, exercise benefits, and/or sleep quality as a function of exercise schedule and behavior. Example work-life and/or calendar data may include scheduled meetings, events, device usage (e.g., email, phone, and other computer/device usage), and other information regarding habits and obligations associated with work. The term “work” as used herein may signify work activities and obligations associated with an occupation, including but not limited to jobs performed at work, work meetings, phone calls, homework, classes, commutes to and from work/school, and business trips, as well as work activities beyond those associated with an occupation, including but not limited to housework, chores, and errands. The term “life” as used herein may signify activities performed during the course of a user's life, such as hobbies, social activities, travel, family activities, and/or other lifestyle occurrences. “Work-life data” may represent data indicative of and/or otherwise related to such activities, and any other scheduled or habitual activities associated with a user's work and/or life outside of work. Work-life data may also include metrics related to work efficiency, such as rate of jobs or tasks completed, emails sent or received, keystrokes, mouse clicks, etc. Further, other obligations besides work may also be considered, including but not limited to social, family or entertainment events on a user's calendar. More detailed examples of health data, work-life data, and the comparison of health data and work-life data are described below.

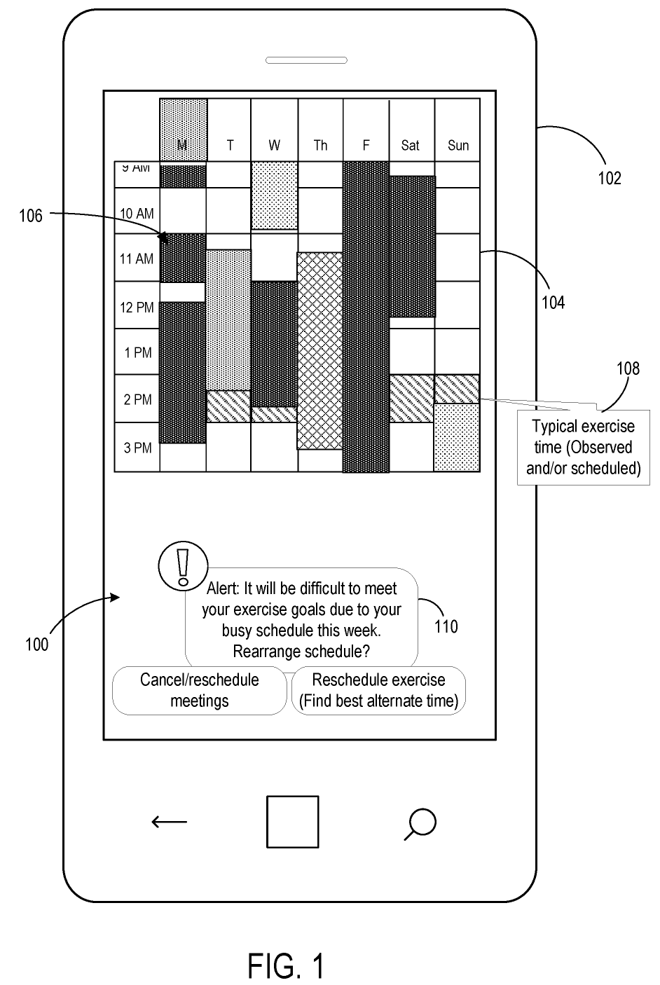

FIG. 1 shows an example calendar user interface 100 on a mobile device 102. User interface 100 includes a user calendar 104 comprising a plurality of scheduled items 106. In this example, an exercise time is indicated at 108 as occurring from 2 pm to 3 pm every day of the week. In some examples, this exercise time may be determined, and potentially automatically reserved on the calendar, based on observations determined from sensor data via machine learning algorithms. Likewise, in some examples, this exercise time may be scheduled by the user. The information in the user calendar 104 may provide a source of health-related data for the user. For example, the entries in the calendar may indicate typical workout schedules for the user, thereby providing information related to a past or expected future amount of exercise performed by the user. The calendar may also provide information regarding a user's whereabouts (e.g., meetings/appointments, vacations/travel, and other entries may be linked to particular locations), activities that the user performed, other individuals with whom the user interacted, and/or other information that may be relevant to an outcome of interest. Accordingly, the data in the calendar may be utilized to help generate insights regarding ways in which a user may meet or achieve an outcome of interest.

In the illustrated example, the scheduled items 106 largely fill the user's calendar, and many of the scheduled items overlap the typical exercise time shown on the calendar. Based upon the user's health data compared to the calendar, the device 102 determines that the user may have difficulty meeting exercise goals, and displays an alert 110 to notify the user of this insight. The depicted alert 110 also provides the user with selectable options of remedial actions to take, illustrated here as an option to reschedule the workout, or to cancel or reschedule one or more of the other scheduled items 106. Upon user selection of “reschedule exercise,” the device 102 may, for example, recommend one or more other times for a user workout that are determined to be beneficial based upon the user's health data, and that do not coincide with the time of scheduled meetings or other scheduled events. Such a determination may take into account other factors than schedule, such as calendar fragmentation (e.g. the rescheduling may offer times that reduce calendar fragmentation), travel time between meetings in different locations, and exercise benefits/efficiency. The rescheduled or added exercise times may be determined on a per-day basis, or may be presented as an updated multi-day schedule of exercise times to help the user meet his/her exercise goals during a given time period (e.g., a week).

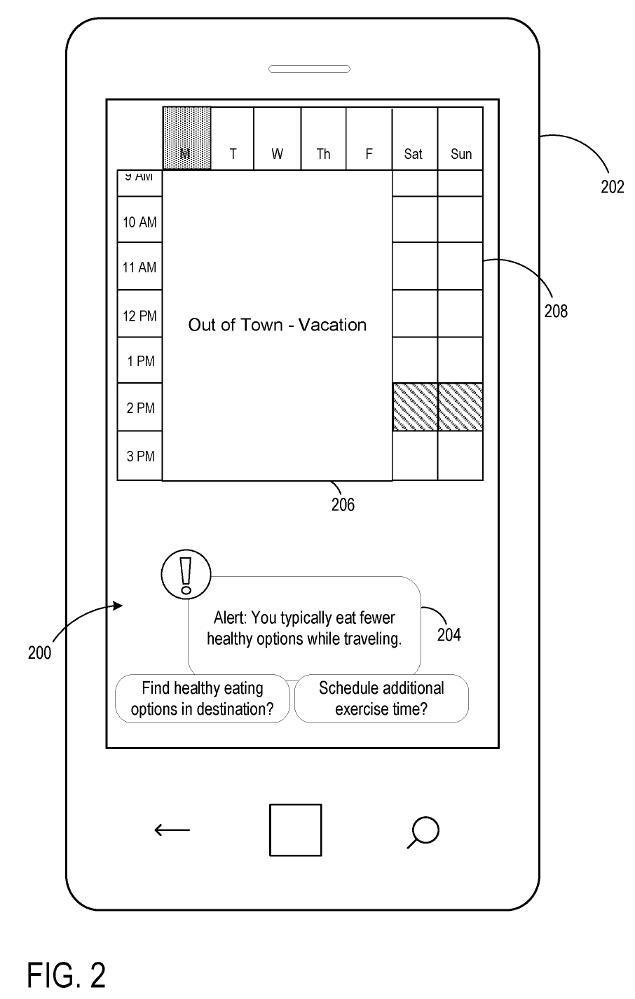

FIG. 2 shows another example use case in which a predictive insight is provided to a user based upon a combination of health data and work-life data. In this example, a computing device 202 displays an alert 204 on a user interface 200 to alert a user that a scheduled vacation 206 on calendar 208 may prevent the user from meeting a health-related goal, such as a calorie consumption or calorie burn goal. The alert 204 also shows responsive options, such as finding healthy eating options near the location of the user in order to reduce calorie consumption, and/or scheduling additional exercise time in order to increase calorie burning relative to typical vacation behaviors of the user. In other examples, an alert may be presented responsive to a prediction made during a scheduling process. For example, upon attempting to schedule a meeting that conflicts with a user's exercise time, an alert may be presented indicating that the meeting may affect the user's ability to meet an outcome of interest (e.g., “you could schedule this meeting for 4 pm, however you will be 50% less likely to meet your step goal if you do”).

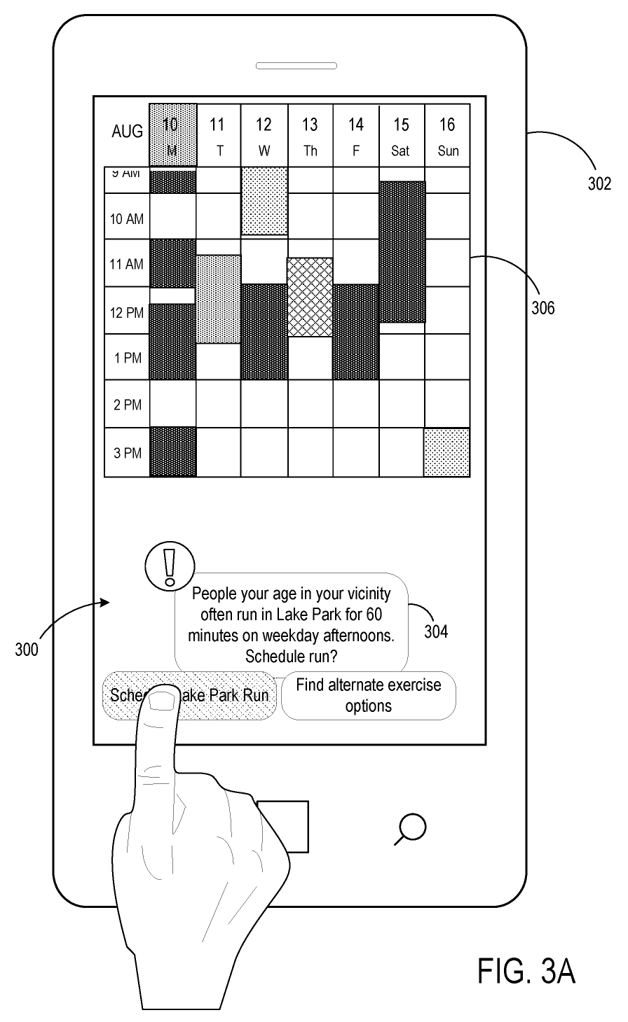

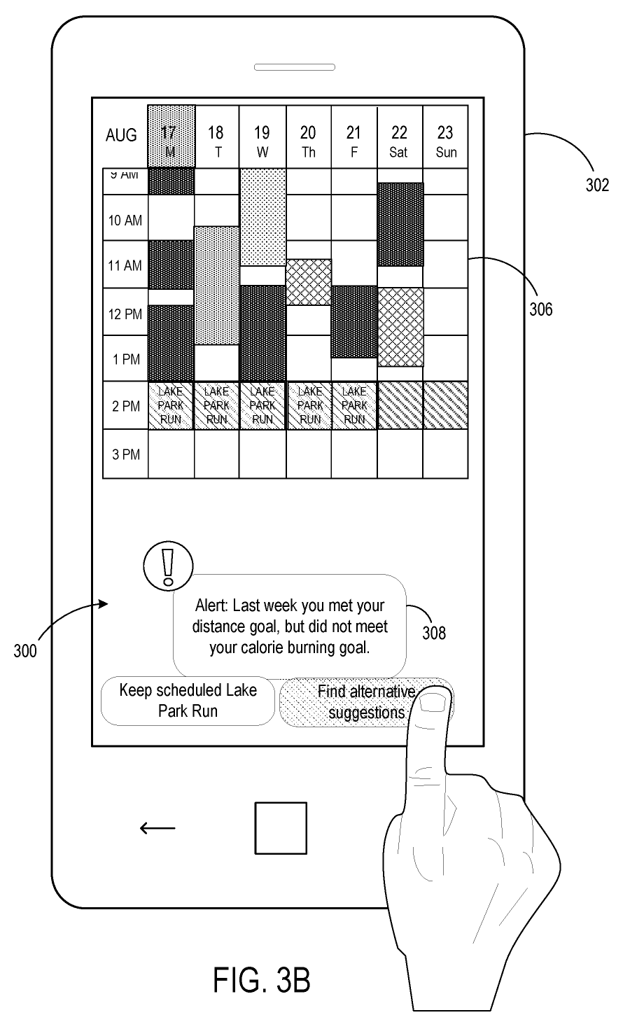

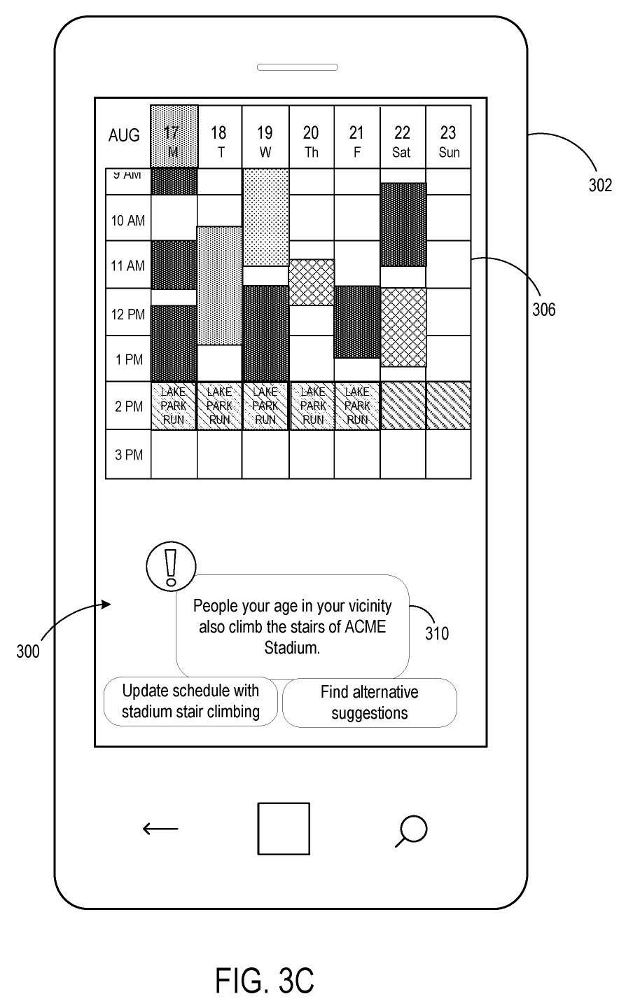

FIG. 3A shows another example of providing an insight to a user based upon a combination of health data and work-life data. In this example, a recommendation for helping a selected user meet an outcome of interest is provided based on information regarding other users that are similar to the selected user. Such similar users also may be referred to herein as “cohorts” of the selected user, and the selected user and cohorts may be collectively referred to as a cohort group. In this instance, computing device 302 displays an alert 304 on a user interface 300 regarding activities of similar users (e.g., users within an age and location range of the selected user) that may help the selected user meet his/her outcome of interest. In this example, the alert 304 informs a user of the computing device that similar users often perform a particular exercise activity (e.g., running) in a location near the user (e.g., Lake Park) for a particular amount of time (e.g., 60 minutes) at a particular time of day (e.g., weekday afternoons). In other examples, any other suitable cohort-based insights may be provided. Such insights into activities of similar users may help the user meet his/her outcome of interest. The alert 304 may also provide option of actions to take, such as scheduling the suggested activity based on a calendar of the user, or finding alternative exercise options. In the illustrated example, the user's weekday afternoons are mostly open, so the afternoon workout schedule of similar users may be of interest to the user of the computing device.

As illustrated in FIG. 3A, upon selecting to schedule the suggested Lake Park Run, the suggested run is scheduled as exercise time during free time periods in the user's calendar 306, illustrated in this example as between 2 pm and 3 pm on weekdays.

Where individual (predictive and/or retrospective) and/or cohort-based insights are used to provide recommendations, activities of a user that received the recommendation may be followed to determine if the recommendation had the intended effect of furthering progress toward the outcome of interest. FIG. 3B shows an example user interface 300 provided after the user has followed the suggested exercise activity for a week. If the health data of the user over the past week indicates that the user met some, but not all, of the outcomes of interest, an alert 308 is displayed to the user, in this instance indicating that the distance goal was met, but the calorie burning goal was not met. The alert 308 may also provide selectable options regarding actions to take, such as finding alternative suggestions for meeting the outcome of interest. In response to selection of the option to find alternative suggestions, as indicated in FIG. 3B, the user interface 300 may be updated to display another suggested activity, as indicated with alert 310 in FIG. 3C. In the example of FIG. 3C, the alternative suggestion includes an indication that people similar to the selected user in age and location also climb stairs of a local stadium, thereby using cohort behavior to recommend alternative activities. The alert 310 may also provide selectable options regarding actions to take, such as updating the user's schedule with the suggested activity or finding other alternative suggestions for meeting the outcome of interest.

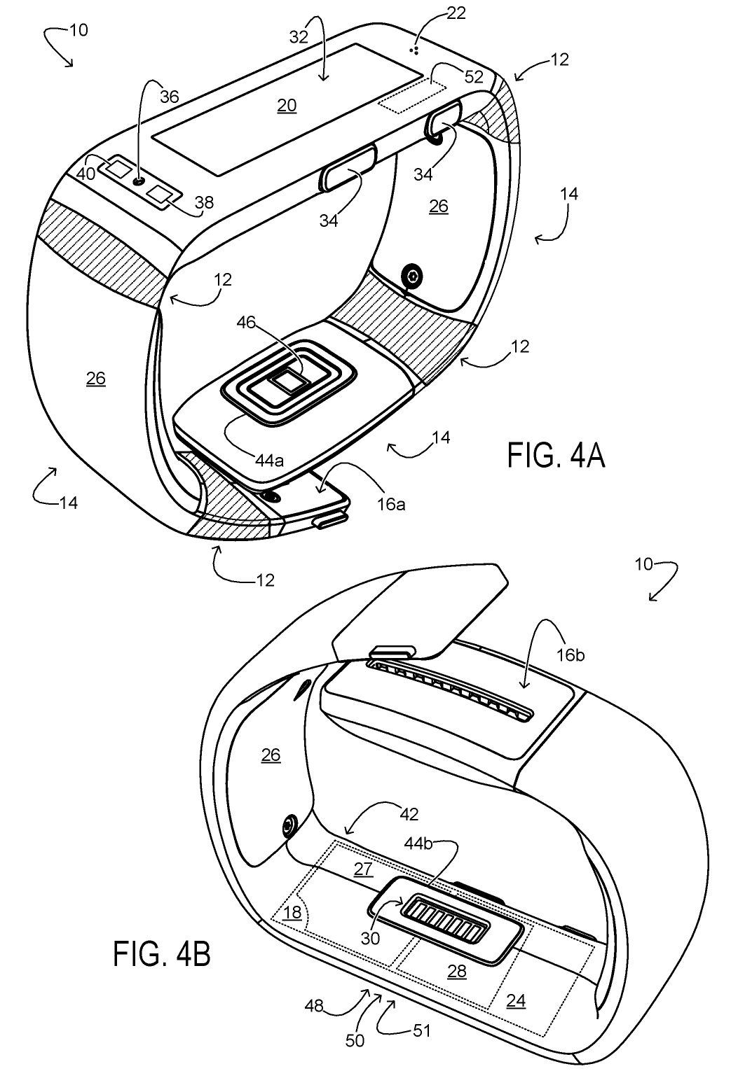

Health data and work-life data (e.g., location data, travel data, and/or other data relating to a user's lifestyle and/or work) may be obtained from various sources. As a non-limiting example, health data and work-life data may be determined from sensor data acquired via a wearable or portable sensor system. In other examples, health data and work-life data may be acquired from any other suitable source or combination of sources. FIGS. 4A and 4B show aspects of a non-limiting example sensory-and-logic system in the form of a wearable electronic device 10 that may be configured to track health data and work-life data, and/or provide sensor data (raw or processed) to a remote device, such as a mobile or desktop computing device, for analysis. It is to be understood that the wearable electronic device 10 is one example of a device that may gather the above-described data, and that other devices, wearable and/or non-wearable, may be used in other examples. The illustrated device is band-shaped and may be worn around a wrist. The depicted wearable electronic device 10 includes a plurality of flexion regions 12 linking less flexible regions 14. The flexion regions 12 of the wearable electronic device 10 may be elastomeric in some examples. Fastening componentry 16a and 16b is arranged at both ends of the wearable electronic device 10. The flexion regions 12 and fastening componentry 16a and 16b enable the wearable electronic device 10 to be closed into a loop and to be worn on a user's wrist. In other examples, wearable electronic devices of a more elongate band shape may be worn around the user's bicep, waist, chest, ankle, leg, head, or other body part. In such an example, a wearable electronic device may take the form of eye glasses, a head band, an arm-band, an ankle band, a chest strap, or an implantable device to be implanted in tissue.

The wearable electronic device 10 includes various functional components integrated into less flexible regions 14. For example, the wearable electronic device 10 includes a computing system 18, display 20, loudspeaker 22, communication suite 24, and various sensors. These components draw power from one or more energy-storage cells 26.

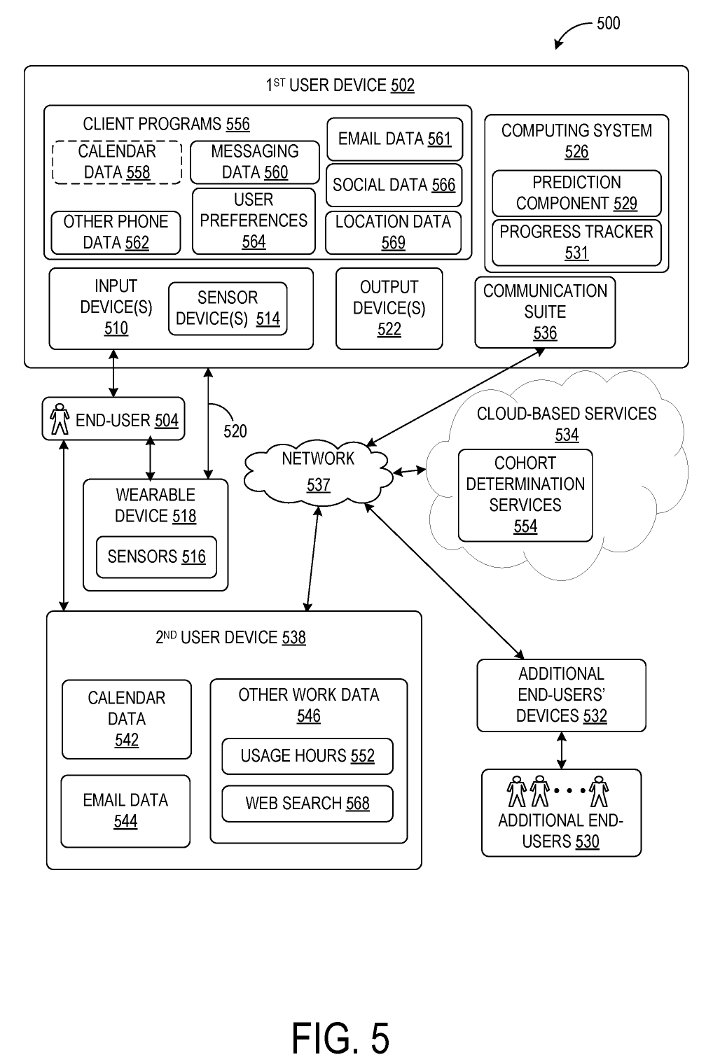

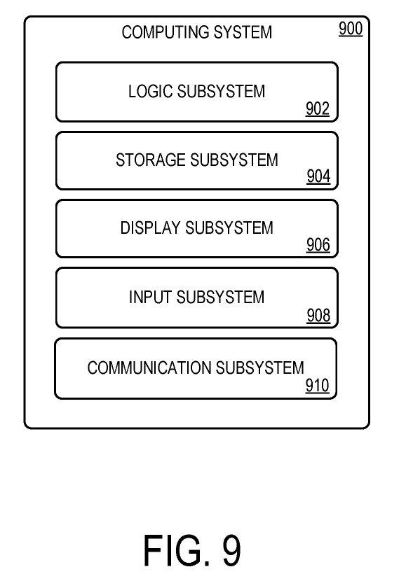

In the wearable electronic device 10, the computing system 18 is situated below the display 20 and operatively coupled to the display 20, along with the loudspeaker 22, the communication suite 24, and the various sensors and other components not depicted (e.g. haptic outputs, such as piezoelectric vibrators). The computing system 18 includes a data-storage machine 27 to hold data and instructions, and a logic machine 28 to execute the instructions. Aspects of the computing system 18 are described in further detail with reference to FIGS. 5 and 9.

The communication suite 24 may include any appropriate wired or wireless communications componentry. In FIGS. 4A and 4B, the communication suite 24 includes USB port 30, which may be used for exchanging data between the wearable electronic device 10 and other computer systems, as well as providing recharge power. The communication suite 24 may further include two-way Bluetooth, Wi-Fi, cellular, near-field communication and/or other radios. In some examples, the communication suite may include an additional transceiver for optical, line-of-sight (e.g., infrared) communication.

In the wearable electronic device 10, touch-screen sensor 32 is coupled to display 20 and configured to receive touch input from the user. Pushbutton sensors may be used to detect the state of push buttons 34, which may include rockers. Input from the pushbutton sensors may be used to enact a home-key or on-off feature, control audio volume, turn the microphone on or off, etc.

FIGS. 4A and 4B show various other example sensors. Such sensors include microphone 36, visible-light sensor 38, ultraviolet sensor 40, and ambient temperature sensor 42. The microphone 36 provides input to the computing system 18 that may be used to measure the ambient sound level or receive voice commands from the wearer. Input from the visible-light sensor 38, ultraviolet sensor 40, and ambient temperature sensor 42 may be used to assess aspects of the wearer's environment—e.g., the temperature, overall lighting level, and whether the wearer is indoors or outdoors.

FIGS. 4A and 4B further show a pair of contact sensor modules 44a and 44b, which contact the wearer's skin when the wearable electronic device 10 is worn. The contact sensor modules 44a and 44b may include independent or cooperating sensor elements to provide a plurality of sensory functions. For example, the contact sensor modules 44a and 44b may provide an electrical resistance and/or capacitance sensory function responsive to the electrical resistance and/or capacitance of the wearer's skin, and thus may be configured to function as a galvanic skin response sensor. In the illustrated configuration, the separation between the two contact sensors provides a relatively long electrical path length for more accurate measurement of skin resistance compared to a shorter path. Further, in some examples, a skin temperature sensor may be integrated into one or both of contact sensor modules 44a and 44b to provide measurement of the wearer's skin temperature.

The wearable electronic device 10 may also include motion sensing componentry, such as an accelerometer 48, gyroscope 50, and magnetometer 51. The accelerometer 48 and gyroscope 50 may furnish inertial and/or rotation rate data along three orthogonal axes as well as rotational data about the three axes, for a combined six degrees of freedom. This sensory data can be used to provide a pedometer/calorie-counting function, for example. Data from the accelerometer 48 and gyroscope 50 may be combined with geomagnetic data from the magnetometer 51 to further define the inertial and rotational data in terms of geographic orientation. The wearable electronic device 10 may also include a global positioning system (GPS) receiver 52 for determining the wearer's geographic location and/or velocity. In some configurations, the antenna of the GPS receiver 52 may be relatively flexible and extend into flexion regions 12.

The computing system 18, via the sensory functions described herein, is configured to acquire various forms of information about the wearer of the wearable electronic device 10. Such information must be acquired and used with utmost respect for the wearer's privacy. Accordingly, the sensory functions may be enacted subject to opt-in participation of the wearer. In implementations where data is collected on the wearable electronic device 10 and transmitted to a remote system for processing, that data may be anonymized. In other examples, data may be confined to the wearable electronic device 10, and only summary data is transmitted to the remote system.

It will be understood that any other suitable sensors not shown in FIGS. 4A and 4B may be included on the wearable electronic device 10, such as a heart rate monitor, one more optical sensors, a barometer to detect changes in atmosphere pressure, an actigraph/actimetry sensor to monitor sleep behavior, etc. It will further be understood that although FIGS. 4A and 4B show a wearable device, the methods and techniques described herein may be operated on any other suitable computing device, including a desktop computing device, a mobile computing device, other wearable computing devices, and computing devices without sensors that may receive data remotely from a sensory-and-logic device such as wearable electronic device 10.

FIG. 5 shows a schematic depiction of an example use environment 500 including a first user device 502 associated with end-user 504. The first user device 502 may correspond to any suitable computing apparatus configured to process user health data and work-life data, such as a smartphone, a tablet, a laptop computer, or a desktop computer. Device 102 of FIG. 1, device 202 of FIG. 2, device 302 of FIGS. 3A-3C, and device 10 of FIGS. 4A and 4B are examples of first user device 502. Additional end-users' device(s) 532, associated with additional end-users 530, may take similar forms.

The first user device 502 includes one or more input devices 510, such as a touch sensor (integrated with or separate from a display), a keyboard, and/or a mouse. The input devices 510 also may include one or more sensor devices 514. In other examples, a user device may not include sensor devices 514, but may receive sensor data from sensors residing on another device, such as from sensors 516 on wearable device 518. Examples of the wearable device 518 include wrist or ankle-worn devices (an example of which is shown by device 10 in FIGS. 4A and 4B), head-mounted devices, and clip-on devices, configured to communicate with the first user device 502, e.g. via a wired or wireless communication link 520. The first user device 502 also includes one or more output devices 522, such as a display, a speaker, and/or a haptic output mechanism. Examples of sensor devices 514 or sensors 516 include one or more image sensors (e.g. video camera(s) and/or depth camera(s)), one or more microphones, one or more motion sensors (e.g. accelerometers, gyroscopes, magnetometers, etc.), an ultraviolet light sensor, an ambient temperature sensor, a galvanic skin response sensor, a skin temperature sensor, an optical heart rate sensor, a GPS sensor, and a barometer. Raw output from such sensors may be analyzed, for example by a computing system 526 of the first user device 502 or directly on the wearable device 518, to determine quantities such as user movements, heart rate, blood pressure, blood oxygenation, calories burned, and sleep-related characteristics (e.g. a number of and frequency of wakeups, cardiovascular activity during sleep, etc.) as a function of time. This information may then be further analyzed to determine measures of sleep quality and one or more exercise benefits, such as exercise efficiency. The information also may be analyzed to determine or recognize progress toward other insights, such as ways to increase productivity, reduce stress, and/or achieve other outcomes of interest.

Temporal information regarding sleep quality, exercise benefits, and other such health characteristics may be correlated with user activities to determine health data for the user, wherein health data comprises information regarding a relationship between health activity scheduling and health outcome. Such relationships may include, for example, health benefits and health efficiencies achieved based on the types of user activities performed, the times at which activities are performed, the duration of the activities, and the location of the activities (e.g., home vs. gym vs. park) compared to exercise benefits, exercise efficiency, sleep quality, and other outcomes (e.g. body weight, body mass index, and weight loss). In addition to sensor data collected by the first user device 502, relationships between health activity scheduling and health outcome also may be determined based at least partially on user inputs. User inputs may be used, for example, to indicate an activity type being performed, an input activating an exercise mode on the first user device 502, and/or any other suitable data useable to correlate health outcome with activity scheduling.

Any suitable correlations between health activity scheduling and health outcomes may be determined in order to provide insights to help the user reach an outcome of interest. For example, the computing system 526 may determine from sensor data that higher exercise efficiency (e.g. calories burned per minute) may be achieved when the user exercises in the morning as opposed to during the evening. As another example, the computing system 526 may determine that days in which the user works out in the morning are correlated with better sleep quality compared to days when the user works out in the evening. As other examples, the computing system 526 may determine that days on which the user performed low-impact exercise (e.g. yoga) were correlated with better sleep quality compared to days on which the user performed strenuous exercise (e.g. vigorous running). The computing system 526 may also detect a correlation between better sleep quality and higher work productivity the next day, and/or a correlation between increased physical activity and reduced stress levels. In some examples, such correlations also may be determined directly on wearable device 518.

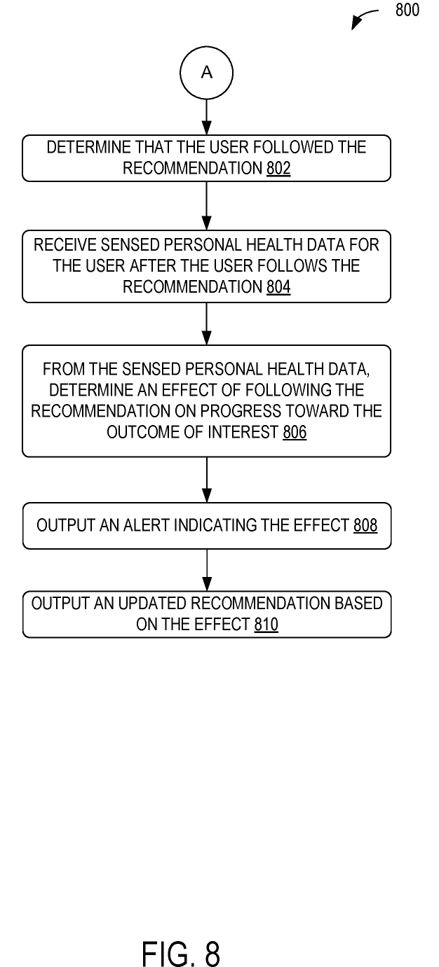

The computing system 526 may also include a prediction component 529 and a progress tracker 531. The progress tracker 531 may determine a user's progress toward an outcome of interest based on past data. Historical data from the progress tracker 531 may be used by the prediction component 529 to predict a likelihood that a user will meet an outcome of interest and/or to provide feedback regarding an effect of following a recommendation on the outcome of interest, as described in more detail with respect to FIG. 8. In some examples, the prediction component 529 may also determine one or more outcomes of interest and/or preferences for the user based on past data.

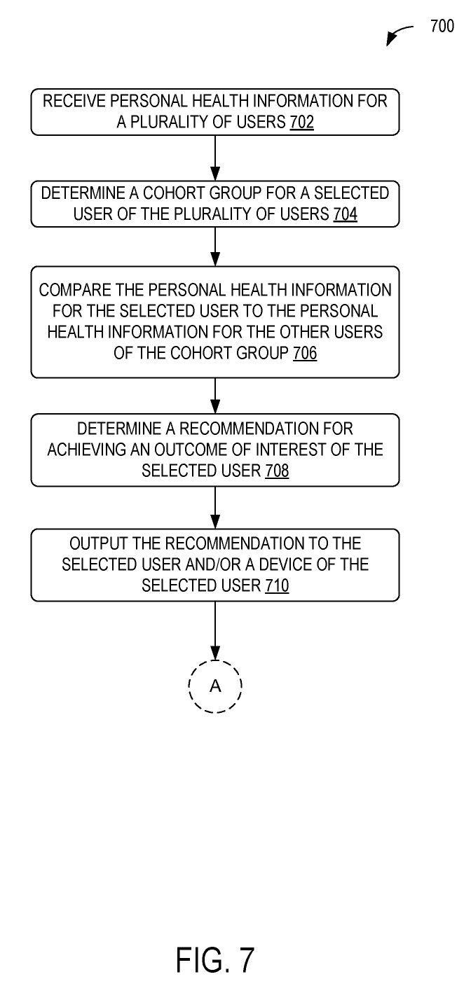

In some examples, population-based health data may be initially used to recommend health activity scheduling for a new user for whom little personal data has been accumulated. Such population data may be obtained from additional end-users 530 and their devices 532 via cloud-based services, illustrated schematically at 534. The population data may be used to determine a cohort group of similar users using cohort determination services 554 (described in more detail with regards to FIG. 7) and/or identify additional insights for end-user 504 based on data received from the additional end-users 530 and their devices 532. As the end-user 504 continues to use the first user device 502, data may be applied to analysis as it is gathered. Data collected from the individual may eventually override the population data with time. For example, an initial recommendation for an activity (e.g. to reach a health outcome goal) may include a selection of activities performed by users determined to be similar to the selected user and that fit into the selected user's schedule. After determining which activities the selected user prefers to perform (e.g., based on user input and/or observations regarding which activities the user skips or performs), updated recommendations may be provided in light of the insight gained by the observed, population, and feedback data.

Health data may be used to provide various recommendations to a user. For example, health data regarding sleep quality, exercise benefits, exercise efficiency, and other suitable outcomes as a function of activities performed and/or times at which activities are performed may be used to suggest times to perform health activities, and/or health activities to perform at those times.

As described above, a user may have many obligations during a day that can interfere with the user's ability to perform the suggested activities at the suggested times and meet a health outcome of interest. For example, analysis of health data alone may indicate that working out in the morning is associated with certain health benefits. If the user has meetings scheduled during the morning for a particular day or multiple days in a week, the user may be unlikely to meet an outcome of interest associated with the suggested activities due to these times being unavailable for health-related activities.

Thus, health data may be utilized in combination with work-life data related to a user's work activities to predict whether a user is likely to achieve an outcome of interest, and to recommend alternative activities in the event that the user is not likely to achieve the outcomes of interest. In FIG. 5, the first user device 502 may have access via communication suite 536 and network 537 to other data, such as calendar data 542, on a second user device 538 of the end user 504, which may represent a work computer in some examples, and wherein the other data may regard a personal or work schedule and/or user or work habits of the end-user 504. The calendar data 542 may inform the first user device 502 of a schedule of the end-user 504, which may be used to suggest workout times which are available to the user for performing health activities.

Other data may also be determined or inferred from other suitable data besides calendar data 542. For example, email data 544 accessible from the second user device 538 may help provide data related to times of work or other user meetings and events, as determined from email content, keywords, invitations, etc. Further, email data 544 may also provide information relating to times when a user is logged in to a work or other email address or has received and sent email correspondences, indicating that the user may likely be working or performing another email-related task. As another example, other data may be inferred from sensor data provided by the first user device 502 and/or the wearable device(s) 518, such as sensor data indicating when the user has been sitting for an extended period of time, GPS data indicating when the user is at a work or other location, etc.

Other work-life data 546 may further include information related to work productivity of the end-user 504, such as device usage hours 552 logged and web search activities 568, stress levels of the end-user 504 (e.g., as estimated using measured or entered heart rate variability combined with other information, such as recent workouts and sleep data), and/or other health-related work-life information.

The first user device 502 also may include client programs 556 including client-side calendar functionality, which may reflect the calendar data 542 on the second user device 538. The client programs 556 may also provide various messaging data 560, email data 561, social data 566, location data 569, user preferences 564, and other phone data 562. Similar to the email data 544, the messaging data 560 and email data 561 may help to inform when the user may have obligations, e.g. from analysis of the content of text invitations, emails (e.g., flight confirmations), alerts, reminders, and the like. The phone data 562 may provide similar information, e.g. from conversation or voicemail content. Work-life data may also be received via user input of work hours during an initial configuration or other user input process. As yet another example, work-life data may also be inferred from GPS data, which may indicate when a user is at a work location.

In some examples, preferences of the end-user 504 may be used to further inform scheduling of events. As such, the client programs 556 may include data regarding user preferences 564. Such preferences may be input by a user, or may correspond to user patterns learned over time. User preferences 564 may comprise any suitable information, such as information regarding when the end-user 504 prefers to work out, a preferred duration of workouts, a prioritization of work meetings compared to health activities, etc.

The first user device 502 may also interact with any suitable additional user devices such as another wearable device, another mobile device, a desktop personal computing device, a laptop computing device, a game console device, a set-top box device, or a tablet-type computing device, as examples. Additional user devices may provide any other suitable data for use in helping to recommend scheduling of events.

The computing system 526 may utilize any or all of the above types of data in combination to compare work-life data and health data to help provide health-related insights (e.g., health-related outcomes or the use of health signals in insights related to other non-health outcomes, such as productivity), such as determining a likelihood that a user will achieve an outcome of interest, and/or to identify cohorts with whom health data may be correlated. Any suitable comparison may be used. Examples include association methods including but not limited to exploratory factor analysis, multiple correlation analysis, support vector machine, random forest, gradient boosting, decision trees, boosted decision trees, generalized linear models, partial least square classification or regression, branch-and-bound algorithms, neural network models, deep learning algorithms, clustering models, association rule learning, and symbolic computation engines. It will be understood that such computations may additionally or alternatively be performed by any other suitable computing device(s) other than the first user device 502.

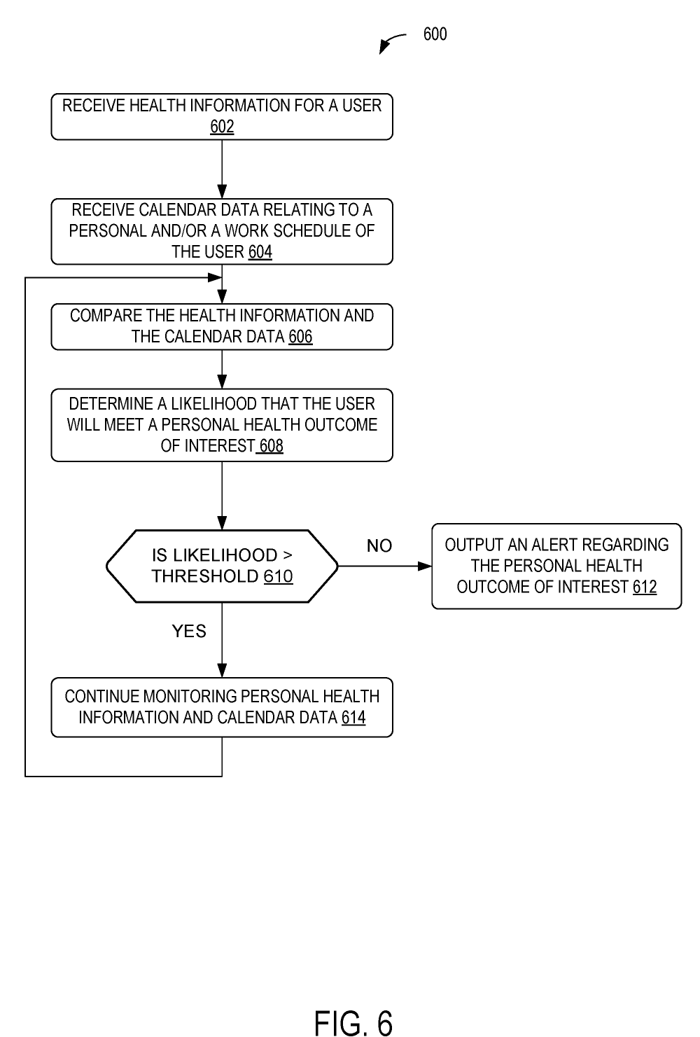

FIG. 6 shows a flow diagram illustrating an example method 600 for determining and outputting an indication of a likelihood that a user will meet a health outcome of interest. For example, if an outcome of interest for a user relates to an amount of exercise to be completed each week, method 600 may be performed to evaluate whether the user is on track to meet that exercise goal, and to output an alert if there is a risk that the goal will not be met.

At 602, method 600 includes receiving health information for a user. The health information may include information regarding health activities performed by the user and/or health metrics for the user. The health information may be sensed information (e.g., indicating a user's activity levels, biometric data, and/or other sensed information), and/or data entered by a user (e.g., health data, preferences, logged activities). At 604, the method 600 further includes receiving calendar data relating to a personal and/or work schedule of the user. For example, the calendar data may include scheduled activities, meetings, and/or other events. In some examples, the health information and/or calendar data also may include information derived from evaluating productivity or email data.

At 606, method 600 includes comparing the health information and the calendar data. The health information may include information regarding a progress toward an outcome of interest, and the calendar data may include schedule data that can be used to determine opportunities to further progress toward the outcome of interest, such as available times for performing exercise in the near future. The comparison also may consider what types of exercise the user may perform at the available times, and the health benefits/efficiencies of each type. Further, the comparison also may consider previously observed behaviors of the user, such as whether the user typically adheres to scheduled exercise times when the user is out of town if there is travel booked for the near future. For example, the comparison of health information and calendar data may include determining a predicted amount of calories that can be consumed based upon a total amount of available time (e.g., exercise time) and/or based upon information regarding past exercise behavior of the selected user.

As another example, the health information and calendar data may be compared to one another to identify scheduling conflicts (e.g., times at which activities not related to the outcome of interest overlap scheduled activities related to the outcome of interest) and/or free time in the user's schedule (e.g., free time that is usable for activities related to the outcome of interest). When determining available time to exercise, sleep times, meal times, commute times, work times, and/or other regular activities that may not be scheduled may be excluded from the free time in the calendar. Out-of-routine times also may be excluded from the free time in the calendar. Out-of-routine times further may be excluded from the data used in computing insights or used as a part of insight creation (e.g., depending on the insight being generated). For example, flight times and/or other travel-related times (e.g., packing, going through security at the airport, etc.) may not be explicitly scheduled in a user's calendar, but may be inferred from flight times and/or other data. As such activities may prevent the user from performing a health activity, they may be excluded from a determination of free time in the user's schedule.

At 608, method 600 includes determining a likelihood that the user will meet a health outcome of interest based on the comparison of the health information and the calendar data. The likelihood may be determined in any suitable manner. As an illustrative example, the likelihood may be determined as an estimated proportion of an outcome of interest that actually will be achieved (e.g., the user is likely to run 18 miles out of the goal of 20 miles per week), or as a probability that the full outcome of interest will actually be achieved. The determined likelihood is then compared to a threshold likelihood at 610. In some examples, the threshold may be fixed, while in other examples, the threshold may be adjusted based upon various factors. As examples, the threshold may be adjusted based on the user's past exercise/health behaviors, such as the user's past success in meeting goals. As a more specific example, if the user met or exceeded the outcome of interest in past weeks, the threshold may be lower than if the user did not meet the outcome of interest in past weeks.

If the likelihood that the user will meet a health outcome of interest is not above the threshold likelihood, method 600 proceeds to 612 to output an alert regarding the health outcome of interest. The alert may include any suitable information. For example, the alert may include information regarding reasons that the user is not likely to meet the outcome of interest (e.g., as indicated at 110 of FIG. 1), and/or a representation of the data that lead to the determination. The alert further may also include a display of selectable actions on a user interface that a user can select to help meet the outcome of interest. Any suitable actions may be presented and/or taken to help a user meet the outcome of interest. Examples include determining a meeting that may be canceled or rescheduled, and an exercise to schedule in its place, or allowing a user to select a meeting to reschedule. On the other hand, if the likelihood that the user will meet a health outcome of interest is above the threshold, then method 600 comprises continuing to monitor health information and calendar data for the user.

FIG. 7 shows a flow diagram depicting an example method 700 for providing insights related to a group of cohorts of a user. At 702, method 700 includes receiving health information for a plurality of users. For example, this information may be received at a server computing system from one or more end user devices of each user of a plurality of users.

At 704, the method includes determining a cohort group for a selected user of the plurality of users. The cohort group may be based upon any suitable information regarding similarities between users, such as location (e.g., region, geographic features, climate/weather patterns, and/or other location information), information related to activities (e.g. amount, type, location, preferences, times performed, etc.), outcomes of interest, and medical or health factors (e.g., dietary restrictions, medications being taken, medical conditions, and/or other medical data selected to be shared by the user). In some examples, similarities in users may be determined by one or more clustering methods, which evaluate trends in a total population of users to determine groupings between users. The clustering methods may be used to determine which types of health information or other data may be selected to find users that are similar to a selected user. For example, a clustering function on a plurality of users to identify shared attributes among the users relating to one or more of location, health condition, user preferences, user habits, demographics, and/or physiological characteristics. For example, user habits may include historic activities that a user performs and/or activities that the user performs habitually (e.g., workout at the same time each day). In other examples, any other suitable methods may be used to identify cohorts.

In some examples, a cohort group may have a fixed definition, such that the same definition is applied each time a cohort group is identified or updated. In other examples, a definition of a cohort group may change based, for example, upon how many cohorts are identified for a selected user. As one such example, tighter constraints may be applied initially, and if too few cohorts are determined, the constraints may be relaxed progressively until a sufficient number of cohorts are identified. As a more specific example, a cohort group may initially be defined as users with an exercise preference of running that are located within 10 miles of the selected user and have an age within 5 years of the age of the selected user. If a number of users in this cohort group is less than a threshold, the location constraint may be relaxed to 20 miles, and/or the age constraint may be relaxed to within 7 years.

At 706, method 700 includes comparing health information for the selected user to health information for the other users of the cohort group. For example, activities being performed to meet a selected outcome of interest of the selected user may be compared to activities of the other users of the cohort group and effects of those activities on the meeting the other users' outcomes of interest. In this way, the effect of activities on users in the cohort group may be used to estimate an effect of those same activities on the selected user, which may be used to provide cohort-related insights to the user. Thus, at 708, method 700 includes determining a recommendation for achieving an outcome of interest of the selected user based on the comparison performed at 710. For example, if users of the cohort group burn more calories biking for 30 minutes than running for 30 minutes, a recommendation for an outcome of interest relating to burning calories may include advising the user to change one or more scheduled runs to bike rides. As another example, cohorts may include users that are interested in the same activity, and parameters of performing that activity may be suggested to the selected user based on health information received for the other users in the cohorts group (e.g., “people who bike in the morning hours have more effective rides”).

At 710, method 700 includes outputting the recommendation to a user interface, for example, as an alert. The alert may include options to take related actions, such as automatically or semi-automatically scheduling recommended activities, as discussed above with respect to FIG. 6). An example of an output of a recommendation based on a cohort group is shown at 304 of FIG. 3A.

After outputting a recommendation, the method may optionally proceed to method 800 of FIG. 8 (as indicated by connector “A” between FIGS. 7 and 8) to determine the effect of following a recommendation on the outcome of interest, and to provide feedback related to following the recommendation. Such feedback may help the selected user to determine whether the recommendation is helpful to meeting the outcome of interest. Thus at 802, method 800 includes determining that the user followed the recommendation, for example, by comparing parameters of the recommendation (e.g. an activity, a time/location at which the activity was performed, etc.) to the user's actual behavior. Where it is determined that the user followed the recommendation, method 800 includes, at 804, receiving sensed health data for the user, and determining an effect of the recommendation from the sensed health data. The effect may be an immediate effect, or an estimated impact of the recommended activity on a longer trend.

At 808, the method includes outputting to a user interface an alert regarding the effect. For example, the alert may include a notification as to whether the recommended activity was more effective than the activity the recommended activity replaced. For example, the alert may indicate whether the user progressed toward the outcome of interest and/or an amount of progress made toward the outcome of interest (e.g., a percentage of progress toward a goal) by performing the recommended activity. The alert also may include on a user interface of selectable user interface controls that present options of actions to take, such as an option to revert to a prior activity (e.g., change future scheduled exercises to a run-based exercise) or schedule a different recommended activity if the recommended activity was not more effective than the prior activity (e.g., if the user is not likely to achieve the outcome of interest after performing the recommended activity). Method 800 further may include, at 810, outputting an updated recommendation based on the effect. For example, if biking were originally recommended, but then determined not to be as effective for the user as running, the updated recommendation may include an option to schedule additional running sessions. The effect may be fed back into the computing system and used to personalize the health-related insights and/or recommendations provided to the user. For example, the types of activities or other actions that are successful in helping a user to meet an outcome of interest may be used to suggest other outcomes that may be of interest to the user, and/or to help the user to meet other outcomes of interest. As another example, the types of activities or other actions that are not successful in helping a user to meet an outcome of interest may not be suggested at later times to meet other outcomes of interest, or may be used to modify the types of recommendations provided to meet the outcome of interest for the user. It will be understood that these specific examples of feedback are intended to be illustrative and not limiting, and that any other suitable feedback regarding an earlier recommendation may be provided.

The above described examples may be included in a system to provide users with an advanced set of health insights based on user data from a variety of sources, including fitness data, personal health information, productivity data, and other sources (e.g., schedule data, geolocation, travel, etc.). The described examples may offer the ability to take a proactive and preventative approach to their health and wellness. The described systems and methods achieve this goal by leveraging user data from one or more sources to provide users with actionable health-related insights. Insights may be informative, relevant, and optionally actionable, either by the user or by the system operating at least in part on the user's behalf. Health insights may be either population-based—based on all users' activity, or personal for the user, either because they are based on the user's own data, or because they are based on crowd data that is relevant to the user, based on cohorts or interests. There are a number of data sources that can be used to provide insights in isolation or when combined across different domains, including fitness data from wearables and phone applications, schedule and location data from personal assistants, search and browse data from search engines, genomics data, and personal health information. These data streams provide value for insight generation to identify correlations (bivariate and multivariate), associations, trends, and anomalies, as well as to support predictions and offer content recommendations. The combination of user data from different sources can also support the generation of unique and differentiating insights depending on the data available.

Health insights may be created based on a user's personal data, or that related to this data. A few examples include demographic or physiological characteristics (Height, Weight, Age, Gender), online behavior: search history, browse history, app download, biometric data from the wearable device, such as workout events, heart rate data, sleep data, schedule data: meetings, patterns, engagement with health action plans, location data such as geolocation, major/minor hubs, visited venues, etc.

The insights may be interesting to the user, either because they are based on personal data (“your sleep efficiency is poor on days when you have many meetings”), based on crowd data that is relevant to the user, and/or cohort based, e.g. demographically and physiologically similar people. Users can be members of multiple cohorts, wherein cohorts can be defined in advance or learned dynamically from user data, can be interests based, e.g. people engaged in similar sport activity (“People who bike in the morning hours have more effective rides”), and location based (“People in your area run more effectively in the morning hours”), as examples.

Insights may have a targeted outcome (“channels”). Channels are topics the user cares about that has specific metrics to optimize or improve. Example of channels include sleep, exercise, stress, nutrition, productivity, disease prevention, and diabetes. The outcome/channel may impact the context where the insight is viewed, as well as its appearance, e.g. an icon representing the outcome/channel may be viewed next to the insight in the user experience.

The insights may have an anatomy as follows, with different parts included depending on the nature of the insight: Fact—what is the discovered information; Relevance/Annotation—what does that mean, explanation why is this relevant and why now; call to action—what action is suggested; outcome/channel—what is the desired outcome that this insight aims to impact. Insights may have a range of properties, including tone, category, confidence, directionality, and range of others that impact how the insight will be presented to the user.

Insights may aim to drive users into action where applicable, suggesting actions such as: schedule time on calendar; engage with a plan; change in habits and patterns by recommending alternative; drill down into data; take follow-up action on at a late date. In some examples of health insights a system may recommend future actions. Actions on a user's behalf may be added (for example: “your runs are more efficient in the morning hours, I blocked your calendar tomorrow morning”). The insights may be surfaced to the users in across user experience canvases, including on-demand (reactive scenarios), proactive, taskbar tease, or notifications.

Rather than recommending actions, the insights may also be observational (reporting behaviors observed from the user) and also provide feedback to them (meant to affect behavior by offering motivational content, whether it has a positive or negative tone).

Any suitable methods may be used to generate these insights, including correlation coefficients (between two variables) to sophisticated supervised, semi-supervised, and unsupervised machine learning methods (including association rule learning) that can learn more rich insights involving multiple variables.

A number of data sources that may be used to provide insights in isolation or when combined across different domains, including fitness data from wearables and phone applications (including steps, sleep, workouts, and heartrate data), schedule and location data from personal assistants, search and browse data from search engines, genomics data, and personal health information. The data are longitudinal and contain a user identifier to attribute long-term activity to the same user.

Example of insights that may be offered include: comparative benchmarks (“People like you burn 1650 calories per day”); bivariate correlations: statistical relationship between two variables; personal correlations (“Your runs are more efficient in morning hours”); crowd correlations; cohort specific (“You exercise more efficiently than most women of your age”); population (“People with lower BMI have better sleep”) trends (e.g. increasing or decreasing trend in a single variable); anomalies (e.g. an abnormal value(s) detection in a single variable); multivariate associations and correlations (correlations between multiple variables (>1) and the outcome variables—these variables and their inter-relationship can be learned from data given a specific outcome); predictions (forecasts about future events, e.g., “considering your schedule this week, it will be difficult to meet your step goal”—predictions can be short-, medium-, or long-term in nature); anomaly correlations (“You consume more calories when you travel”); and cohort-based recommendations (“a popular biking trail in Redmond is the Sammamish River trail”).

With many different types and sources of insights, care needs to be taken in combining and presenting the insights to remove duplicates and also handle conflicts between multiple insight sources. The signals that may be used for the generation of insights include biometric data, such as heartrate, but also other signals that might be suggestive of evolving interests over time. For example, search queries that may suggest a particular focus of attention, e.g., intense interest in symptoms related to the possible presence of a medical condition.

In some examples insights may be accompanied by an explanation. For example, anomalies in activity may be linked to travel patterns or other factors that may be observable from user data. If data related to events that are atypical for the user are present (e.g., the user is traveling and that is impacting their travel patterns), these out-of-routine periods can be ignored in computations of some insights (e.g., trends in activity) or used as explanations in the computations of others (e.g., anomalies in behavior). The explanations may be presented to the user alongside indications of the associated insights, and/or may be presented responsive to a request from the user to view more information about the associated insights. The explanations may include an indication of the health information, calendar data, and/or comparison of health information and calendar data that was used to determine the insights.

User cohorts may be defined in multiple ways. They can be defined beforehand based on user attributes such as age, gender, or location, and/or based on their degree of interest in relevant topics. They can also be learned dynamically from the data using clustering methods or unsupervised learning techniques. Not all cohorts may be applied to all types of insights. The cohort selected may attempt to be as specific as possible, and if no correlation or association is detected within the cohort, the system may withdraw to a wider cohort. Crowd insights may be configured to be relevant to the user they are associated with. In order for a crowd insight to be associated with a specific user, it may meet cohort association criteria such as the following examples: the insight reflects demographically and/or physiologically similar people; the insight is related to something the user is interested in, like sport activity type (e.g., bike) or domain the user seeks to improve (e.g., sleep); the insight is related to the user's location.

Heuristics may be used to associate a user to a cohort based on minimum support and pre-specified ranges related to factors such as weekly cardio minutes, age, location (e.g., within same state), and user activity (at least x activities within the last y months).

Collection and monitoring of feedback on the insights, whether explicit (thumbs up/thumbs down) or implicit (contrasting user activity before and after the insight has been read) may be used to help understanding the utility of the insights, which may feed into methods for ranking and recommending insights for presentation to users.

User health preferences may be learned from a range of user data sources, including action plan memberships, search activities, application installs, browse data, activities logged, etc. These preferences can inform the selection of specific interests likely to be of use to specific users on a per-user basis or (to address cold start issues if user data are lacking) with the cohort(s) to which they belong.

Insights may be displayed in a number of different places, including on a wearable device, on the phone, inside applications, through the operating system (as notifications in popups or on a taskbar, for example), or even in third-party applications. Richer data could also support the creation of additional insights beyond the fitness focus, including those leveraging personal health information (from electronic health records, lab tests, claims data, and/or other health information sources), and those from genomics data (e.g., “You have a C variant of the CYP1A2 gene—drinking coffee later in the day will severely impact your sleep”).

For insights concerning sensitive health issues (e.g., early detection of disease), it may not be appropriate to show the insight directly on the canvas for all users to see. These insights may be shared with the user privately via communication channels such as electronic mail or text message. With user consent, the insights may also be shared directly with medical professionals.

Accordingly, the above-described systems and methods may include the following aspects: generation of health insights based on user data mined from different sources, generating insights using top-down (hypothesis driven) and bottom-up (data driven) methods, generation of health insights by combining signals from different sources of user data, scoping the insights to different populations, ranging from personal, cohort, and general population, and/or identification of users (including user cohorts) for whom specific health insights may be of interest.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 9 schematically shows an example computing system 900 that can enact one or more of the methods and processes described above. The computing system 900 is shown in simplified form. The computing system 900 may take the form of one or more personal computers, server computers, tablet computers, home-entertainment computers, network computing devices, gaming devices, mobile computing devices, mobile communication devices (e.g., smart phone), and/or other computing devices. The various computing devices and wearable devices described earlier herein may be examples of computing system 900.

The computing system 900 includes a logic subsystem 902 and a storage subsystem 904. The computing system 900 may optionally include a display subsystem 906, input subsystem 908, communication subsystem 910, and/or other components not shown in FIG. 9.

The logic subsystem 902 includes one or more physical devices configured to execute instructions. For example, the logic subsystem 902 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic subsystem 902 may include one or more processors configured to execute software instructions. Additionally or alternatively, the logic subsystem 902 may include one or more hardware or firmware logic machines configured to execute hardware or firmware instructions. Processors of the logic subsystem 902 may be single-core or multi-core, and the instructions executed thereon may be configured for sequential, parallel, and/or distributed processing. Individual components of the logic subsystem 902 optionally may be distributed among two or more separate devices, which may be remotely located and/or configured for coordinated processing. Aspects of the logic subsystem 902 may be virtualized and executed by remotely accessible, networked computing devices configured in a cloud-computing configuration.

The storage subsystem 904 includes one or more physical devices configured to hold instructions executable by the logic subsystem 902 to implement the methods and processes described herein. When such methods and processes are implemented, the state of the storage subsystem 904 may be transformed—e.g., to hold different data.

The storage subsystem 904 may include removable and/or built-in devices. The storage subsystem 904 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. The storage subsystem 904 may include volatile, nonvolatile, dynamic, static, read/write, read-only, random-access, sequential-access, location-addressable, file-addressable, and/or content-addressable devices.

It will be appreciated that storage subsystem 904 includes one or more physical devices. However, aspects of the instructions described herein alternatively may be propagated by a communication medium (e.g., an electromagnetic signal, an optical signal, etc.) that is not held by a physical device for a finite duration.

Aspects of the logic subsystem 902 and storage subsystem 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, the display subsystem 906 may be used to present a visual representation of data held by the storage subsystem 904. This visual representation may take the form of a graphical user interface (GUI). As the herein described methods and processes change the data held by the storage machine, and thus transform the state of the storage machine, the state of the display subsystem 906 may likewise be transformed to visually represent changes in the underlying data. The display subsystem 906 may include one or more display devices utilizing virtually any type of technology. Such display devices may be combined with the logic subsystem 902 and/or storage subsystem 904 in a shared enclosure, or such display devices may be peripheral display devices.

When included, the input subsystem 908 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, the communication subsystem 910 may be configured to communicatively couple the computing system 900 with one or more other computing devices. The communication subsystem 910 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow the computing system 900 to send and/or receive messages to and/or from other devices via a network such as the Internet.

Another example provides for a computing system, including a logic subsystem comprising a logic device, and a storage subsystem comprising a storage device, the storage subsystem including instructions executable by the logic subsystem to receive health information for a user, receive calendar data relating to one or more of a personal schedule and a work schedule of the user, compare the health information and the calendar data to determine a likelihood that the user will meet a health outcome of interest, and, based at least upon determining that the likelihood is below a threshold likelihood, output an alert regarding the health outcome of interest. In such an example, the instructions may additionally or alternatively be further executable to output an explanation of the health information and/or calendar data used to determine the likelihood that the user will meet the health outcome of interest. In such an example, the health information may additionally or alternatively include information regarding one or more of monitored biometric data for the user, monitored fitness data for the user, health records and/or lab test information for the user, monitored sleep data for the user, and genomics data for the user. In such an example, the biometric data, fitness data, and sleep data may additionally or alternatively be monitored over a period of time. In such an example, receiving the health information for the user may additionally or alternatively include receiving the health information from a plurality of health information sources. In such an example, the instructions may additionally or alternatively be executable to compare the health information and the calendar data by determining an amount of conflicting exercise time and work meeting time. In such an example, the instructions may additionally or alternatively be executable to compare the health information and the calendar data by determining a total amount of available time to exercise. In such an example, the instructions may additionally or alternatively be executable to determine the total amount of available time to exercise by excluding one or more of sleep times, commute times, meal times, out-of-routine times, and work times. In such an example, the instructions may additionally or alternatively be executable to compare the health information and the calendar data by determining a predicted amount of calories that can be consumed based at least upon the total amount of available time and also based at least upon information regarding past exercise behavior of the user and/or past user behavior patterns in an associated context. In such an example, the information regarding the past exercise behavior of the user may additionally or alternatively include information regarding one or more of an exercise benefit, exercise efficiency, and effects of exercise behavior on sleep quality. In such an example, the alert may additionally or alternatively include a recommendation to adjust a schedule of the user. In such an example, the recommendation may additionally or alternatively be based at least upon a cohort group of other users determined to be similar to the user. In such an example, the cohort group may additionally or alternatively be based at least upon similarities with regard to one or more of location, health condition, user preferences, and user habits of the user and the other users determined to be similar to the user. Any or all of the above-described examples may be combined in any suitable manner in various implementations.

Another example provides for a computing system, including a logic subsystem comprising a logic device, and a storage subsystem comprising a storage device, the storage subsystem comprising instructions executable by the logic subsystem to receive, for each user of a plurality of users, health information comprising information regarding one or more of health activities performed by the user and health metrics for the user, for a selected user of the plurality of users, determine a cohort group comprising other users determined to be similar to the selected user with regard to one or more of location, health condition, user preferences, and user habits, compare the health information for the selected user with the health information for each user of the cohort group, and output a recommendation for achieving an outcome of interest of the selected user based at least on a result of comparing the health information for the selected user with the health information for each user of the cohort group. In such an example, the instructions may additionally or alternatively be executable to determine the cohort group are executable to perform a clustering function on the plurality of users to identify shared attributes relating to one or more of location, health condition, user preferences, genomics data, physiological signals, and user habits. In such an example, the recommendation may additionally or alternatively include an activity performed by users of the cohort group. In such an example, the recommendation may additionally or alternatively include one or more of a location at which to perform the activity and a time at which to perform the activity. In such an example, the instructions may additionally or alternatively be executable to monitor health data to determine that the user performed the activity, to determine whether the user progressed toward the outcome of interest by performing the activity, and to output an alert based upon one or more of whether the user progressed toward the outcome of interest and an amount of progress toward the outcome of interest. In such an example, the instructions may additionally or alternatively be executable to provide a different recommendation based upon determining that the user is not likely to achieve the outcome of interest. Any or all of the above-described examples may be combined in any suitable manner in various implementations.

Another example provides for a computing system, including a logic subsystem comprising a logic device, and a storage subsystem comprising a storage device, the storage subsystem comprising instructions executable by the logic subsystem to receive health information for a user comprising information regarding health activities performed by the user, receive calendar data for the user relating to one or more of a personal schedule and a work schedule of the user, output a recommendation for achieving an outcome of interest for the selected user based at least upon the health information for the user and the calendar data for the user, determine that the user followed the recommendation based at least upon one or more of user input and sensed activity data for the user, from sensed health data for the user received after determining that the user followed the recommendation, determine an effect of following the recommendation on progress toward the outcome of interest, and output an alert regarding the effect. In such an example, the alert regarding the effect may additionally or alternatively include a recommendation to perform a different activity. In such an example, the recommendation to perform the different activity may additionally or alternatively be based at least upon a cohort group of other users determined to be similar to the user. In such an example, the cohort group may additionally or alternatively be based at least upon similarities with regard to one or more of location, health condition, user preferences, user physiological signals, user genomics, and user habits of the user and the other users determined to be similar to the user. In such an example, the recommendation to perform the different activity may additionally or alternatively be output based at least upon a prediction that a previously scheduled activity and/or an activity to be scheduled would not likely help the user meet an outcome of interest. In such an example, the instructions may be further executable to provide the effect to the computing system as feedback to personalize future insights provided to the user. Any or all of the above-described examples may be combined in any suitable manner in various implementations.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
a logic subsystem comprising a logic device; and
a storage subsystem comprising a storage device, the storage subsystem comprising instructions executable by the logic subsystem to
receive health information for a user,
receive calendar data relating to one or more of a personal schedule and a work schedule of the user,
compare the health information and the calendar data to determine a likelihood that the user will meet a health outcome of interest, and
based at least upon determining that the likelihood is below a threshold likelihood, output an alert regarding the health outcome of interest.

2. The computing system of claim 1, wherein the instructions are further executable to output an explanation of the health information and/or calendar data used to determine the likelihood that the user will meet the health outcome of interest.

3. The computing system of claim 1, wherein the health information includes information regarding one or more of monitored biometric data for the user, monitored fitness data for the user, health records for the user, monitored sleep data for the user, and genomics data for the user.

4. The computing system of claim 3, wherein the biometric data, fitness data, and sleep data is monitored over a period of time.

5. The computing system of claim 1, wherein receiving the health information for the user includes receiving the health information from a plurality of health information sources.

6. The computing system of claim 1, wherein the instructions are executable to compare the health information and the calendar data by determining an amount of conflicting exercise time and work meeting time.

7. The computing system of claim 1, wherein the instructions are executable to compare the health information and the calendar data by determining a total amount of available time to exercise.

8. The computing system of claim 7, wherein the instructions are executable to determine the total amount of available time to exercise by excluding one or more of sleep times, commute times, meal times, out-of-routine times, and work times.

9. The computing system of claim 7, wherein the instructions are executable to compare the health information and the calendar data by determining a predicted amount of calories that can be consumed based at least upon the total amount of available time and also based at least upon information regarding past exercise behavior of the user and/or past user behavior patterns in an associated context.

10. The computing system of claim 9, wherein the information regarding the past exercise behavior of the user comprises information regarding one or more of an exercise benefit, exercise efficiency, and effects of exercise behavior on sleep quality.

11. The computing system of claim 1, wherein the alert comprises a recommendation to adjust a schedule of the user.

12. The computing system of claim 11, wherein the recommendation is based upon a cohort group of other users determined to be similar to the user.

13. The computing system of claim 12, wherein the cohort group is based upon similarities with regard to one or more of location, health condition, user preferences, and user habits of the user and the other users determined to be similar to the user.

14. A computing system, comprising:
a logic subsystem comprising a logic device; and
a storage subsystem comprising a storage device, the storage subsystem comprising instructions executable by the logic subsystem to
receive, for each user of a plurality of users, health information comprising information regarding one or more of health activities performed by the user and health metrics for the user;
for a selected user of the plurality of users, determine a cohort group comprising other users determined to be similar to the selected user with regard to one or more of location, health condition, user preferences, and user habits;
compare the health information for the selected user with the health information for each user of the cohort group; and
output a recommendation for achieving an outcome of interest of the selected user based at least on a result of comparing the health information for the selected user with the health information for each user of the cohort group.

15. The computing system of claim 14, wherein the instructions executable to determine the cohort group are executable to perform a clustering function on the plurality of users to identify shared attributes relating to one or more of location, health condition, user preferences, genomics data, physiological signals, and user habits.

16. The computing system of claim 15, wherein the recommendation comprises an activity performed by users of the cohort group.

17. The computing system of claim 16, wherein the recommendation comprises one or more of a location at which to perform the activity and a time at which to perform the activity.

18. The computing device of claim 16, wherein the instructions are executable to monitor health data to determine that the user performed the activity, to determine whether the user progressed toward the outcome of interest by performing the activity, and to output an alert based upon one or more of whether the user progressed toward the outcome of interest and an amount of progress toward the outcome of interest.

19. The computing device of claim 18, wherein the instructions are executable to provide a different recommendation based upon determining that the user is not likely to achieve the outcome of interest.

20. A computing system, comprising:
a logic subsystem comprising a logic device; and
a storage subsystem comprising a storage device, the storage subsystem comprising instructions executable by the logic subsystem to
receive health information for a user comprising information regarding health activities performed by the user,
receive calendar data for the user relating to one or more of a personal schedule and a work schedule of the user,
output a recommendation for achieving an outcome of interest for the selected user based at least upon the health information for the user and the calendar data for the user;
determine that the user followed the recommendation based at least upon one or more of user input and sensed activity data for the user;
from sensed health data for the user received after determining that the user followed the recommendation, determine an effect of following the recommendation on progress toward the outcome of interest;
output an alert regarding the effect; and
provide the effect to the computing system as feedback to personalize future insights provided to the user.
